(19) United States
(12) Patent Application Publication
(10) Pub. No.: US 2012/0042491 A1
(43) Pub. Date: Feb. 23, 2012

(54) APPARATUS AND METHOD FOR INSTALLING A TRACK ON A TRACKED VEHICLE

(76) Inventors: Christopher Ramsey, Mulkeytown, IL (US); William H. Withrow, Mulkeytown, IL (US)

(21) Appl. No.: 13/215,872

(22) Filed: Aug. 23, 2011

Related U.S. Application Data
(60) Provisional application No. 61/376,084, filed on Aug. 23, 2010.

(51) Int. Cl. B23Q 1/00

(52) U.S. Cl. 29/283

(57) ABSTRACT

An apparatus or tool for installing a continuous loop of track onto the idler wheel or sprocket of a tracked vehicle, including a pair of track grippers configured and operable for gripping at least opposite edges of a portion of the track to be installed over the idler wheel or sprocket, and shaping the portion of the track into an arc of appropriate size for passage laterally over the idler wheel or sprocket, each of the grippers having a rigid, generally arcuate or angular shape suitable for gripping the opposite edges of the portion of the track portion for forming and holding it in an arc; and arms that support and hold the grippers in a generally parallel, spaced apart relation such that the gripping element or elements of the respective grippers are in opposing relation and are spaced a distance apart corresponding about to the width of the track, so as to be capable of capturing or bounding the portion of the track to be installed onto the idler, and for positioning the gripping element or elements for supporting and holding the track in the arc shape, and apparatus configured and operable for spreading the grippers apart for receiving the track therebetween.

This application claims the benefit of U.S. Provisional Application No. 61/376,084, filed Aug. 23, 2010.

### TECHNICAL FIELD

This invention relates generally to an apparatus or tool and a method of use of the same for installing a continuous loop of track onto the wheels or sprockets of a tracked vehicle, which substantially reduces or eliminates need for use of pry bars and other leverage devices, come along winches, manual manipulation, and the like, providing a safer, faster method compared to known practices.

### BACKGROUND ART

U.S. Provisional Application No. 61/376,084, filed Aug. 23, 2010, is incorporated herein by reference in its entirety.

Installing or reinstalling a track on a tracked vehicle or work machine, such as a track loader, track hoe, bulldozer, and other tracked agricultural, construction, earth moving, forestry, or mining machines, and military and police vehicles, is usually a time consuming and often dangerous task. In this latter regard, on job sites such as open air mines and quarries, machines sometimes lose a track in dangerous environments such as next to or at the base of rock faces where blasting has recently occurred, such that falling rocks is a continuous danger. Tracks are also commonly lost when traversing hill sides and the like. Thus, the ability to install or reinstall a track in an expedient manner, requiring as few personnel as possible, is advantageous, both from a productivity perspective, and a safety perspective.

The track is a loop of rubber or metal, and includes outwardly facing ground contacting plates or pads which can include treads for traction. The track includes inwardly facing drive lugs which cooperatively engage mating lugs on the drive sprocket or wheel drivingly rotatable for driving the track. The drive lugs on the track are either in the form of recesses or inward projections on the inner surface of the track that cooperatively receive, or are received in, mating lugs on the drive sprocket or wheel. These lugs on the track also engage or partially encircle a groove or raised element on the idler for holding the track in alignment with the drive sprocket or wheel, the idler, and any bogeys or other wheels of the vehicle or machine.

The process of installing or reinstalling a track, also referred to as “retracking”, involves jacking or otherwise raising and supporting the affected side of the vehicle, sometimes under the dangerous conditions mentioned above. The pressure in a track tensioning system in connection with an idler roller or wheel, usually at the front of the machine, must also be relieved and the idler retracted, usually toward the rear of the machine. The rear arc of the track will either already encircle the drive wheel, or will be placed thereabout. The bottom run of the track will then extend forwardly at a small acute angle to a fore and aft axis running between the drive wheel and idler. The front arc and top run of the track will be freestanding, but will typically sag under its weight so as to have a height and an arc radius smaller than that required for installation, that is, passage over the idler wheel. In this latter regard, the arc radius and height must exceed that of the idler, so that the lugs can pass about the outer circumferential surface of the idler. The slack must also be taken out of the track to provide the length necessary to encircle the idler. The track is then pushed or dragged sidewardly into alignment with the fore and aft drive wheel to idler axis. It may be possible to do this and take the slack out by manual manipulation. But, for larger tracks, a pry bar or bars, overhead crane, come along winch, or other tool or tools is/are often required to force the front arc of the track about the idler, which often entails tensioning the track to its largest lengthwise extent. Then, the track must be manipulated over the idler, which typically entails forcing a portion of the track at a time over the edge of the idler using tools such as pry bars, chains, or the like. In this regard, because the track is flexible or of hinged construction, those portions of the track not supported will sag, which often makes the fitting of the track about the idler a time consuming and frustrating task, resulting in lost productivity. Damage can also be caused by the use of pry bars, hammers, and other tools. Once the track is in place, the idler is tensioned and the side of the machine lowered to return the machine to operation.

### SUMMARY OF THE INVENTION

What is disclosed is an apparatus or tool for installing a continuous loop of track onto the idler wheel or sprocket of a tracked vehicle, which substantially reduces or eliminates need for use of pry bars and other leverage devices, come along winches, manual manipulation, and the like, providing a safer, faster method compared to known practices such as set forth above.

According to a preferred aspect of the invention, the apparatus includes a pair of track grippers configured and operable for gripping at least the edges of the portion of the track to be installed or reinstalled over the idler wheel or sprocket, and shaping that portion of the track into an arc of appropriate size for passage laterally over the idler wheel or sprocket, hereinafter also referred to by just the term “idler”.

Each gripper preferably forms or is formable in a rigid, generally arcuate or angular shape suitable for gripping the opposite edges of the track portion for forming and holding it in the required size arc. The gripper is also sufficiently robust to be capable of being pulled or carried while holding the edge of the track in the arc shape, and for taking slack out of or tensioning the track as required and moving the track laterally over and onto the idler, which entails passage of the lugs over the idler also. This de-slacking or tensioning and movement can be accomplished manually for some lighter tracks, such as the rubber track or belt of a compact track loader or bulldozer, and heavier tracks will require powered assistance, such as from a crane, or the bucket, blade or fork of a work machine or vehicle, or the tracked vehicle or machine itself.

As non-limiting structural examples, the grippers can comprise rigid structures of tubular or solid metal such as steel or aluminum, such as weldments; castings; or extruded shapes curved or bent to the desired arc shape and size. As another non-limiting example, the grippers can comprise assemblies, such as angularly related segments hingedly or pivotally connected together in end to end relation so as to be relatively movable into the desired arc shape, and fastened or restrained in that shape, for instance, by threaded fasteners, pins, turnbuckles, hydraulic cylinders, or other suitable apparatus. With regard to the term “arc shape” this is to be interpreted as including a series of straight segments in end to end, angularly related pattern, forming a generally angularly arced shape, as well as a smoothly curved shape.

According to another preferred aspect of the invention, each of the grippers includes either a single, continuous gripping element, or a plurality of individual or discrete gripping elements or cleats, positioned and oriented to extend in an inward direction toward the other gripper, and configured for cooperatively engaging the edge of the track for gripping and holding or supporting the track portion in the arc shape, and for de-slacking or tensioning and carrying it laterally into position on the idler. As non-limiting examples, the single continuous gripping element can comprise a flange or lip formed in the arc shape and size, and the individual gripping elements can comprise plates, tabs, pins, bolts, and/or prongs, arranged in an arcuate or angularly related pattern. As one option, if sufficient clearance is available, the gripping elements can comprise removable pins which extend across the space between the grippers. As another option, the gripping element or elements can be in the form of inwardly facing grooves configured for cooperatively receiving the edge of the track, and can optionally be configured for holding it using a clamping action.

The invention additionally includes arms that support and hold the grippers in a generally parallel, spaced apart relation such that the gripping element or elements of the respective grippers are in opposing relation and are spaced a distance apart corresponding about to the width of the track, so as to be capable of capturing or bounding the portion of the track to be installed onto the idler, and positioning the gripping element or elements for supporting and holding the track in the arc shape. In this latter regard, the arms can be adjustable for different width tracks, or non-adjustable but capable of being opened and closed or assembled for positioning about a track of a particular width.

As a non-limiting example of adjustable arms, a sidewardly telescoping assembly can be used wherein two arms, each carrying a gripper are relatively telescoping sidewardly, that is, inwardly or outwardly, one relative to the other, or both relative to a center or main member. As another example, the arms can be relatively movable via a scissors or pivotal connection. In either instance, the arms can be fixed or retained in a set position via suitable apparatus such as a pinned connection, turnbuckle or hydraulic cylinder, these latter apparatus being usable also for adjustably moving the arms.

According to another preferred aspect of the invention, the grippers can be removably mounted or attached to the ends of the arms, for breaking down or compacting the apparatus for transport and storage, and to allow interchanging different size grippers for use with different size tracks or idlers. Thus, as an example, a larger radius gripper for use with a larger radius idler can be interchanged with a smaller radius gripper for use with a smaller radius idler, and/or a medium size gripper, or a gripper for a different style or type of track, e.g., a rubber track or steel track. As a non-limiting example, this removable attachment can be achieved with removable pins or bolts, or hooks. Thus, for example, an apparatus having telescopically or pivotally adjustable arms can be provided in combination with multiple sets of interchangeable grippers of different sizes for use with a variety of different track configurations and sizes.

According to another aspect of the invention, the apparatus can be suspended by an overhead structure, such as, but not limited to, a crane or gantry, for instance, as commonly found on equipment service vehicles and in repair shops. It can also be suspended from an element of the tracked machine or vehicle itself or another vehicle or machine, such as from a bucket or blade thereof, or a structural support thereof such as a cylinder or arm carrying the bucket or blade. In one embodiment, the apparatus of the invention will be suspended from a service truck crane positionable next to the track and movable in a manner for taking the necessary slack out of or tensioning the track and moving it laterally toward and over the idler.

As an aspect of the method of the invention, the side of the tracked vehicle or machine on which the track is to be installed or reinstalled, will have to be elevated. This can be done, if possible, using a crane, or with a jack or jacks, or an inflatable bag or bags. The vehicle or machine can then be supported on timbers, stands, cribbing, or an inflated bag or bags during the installation. As another aspect, the pressure in the idler support will be relieved, and the idler retracted. As another aspect of the method of the invention, the apparatus will be fitted and installed about the end of the track. This will entail selection of grippers sufficiently large to form the end of the track in a large enough arc shape to partially encircle the idler with sufficient margin for passage of the lugs over the circumference of the idler. The apparatus, thus installed on the track, will then be used to take the slack out of or tension the track as required for passage over the idler. As a next or in the same step, the track can then be carried by the apparatus laterally into position about the idler. Here, the apparatus can be supported on a stand, movable over the ground or other surface below the apparatus, such as on wheels or skids, or on a dolly, or it can be supported on or from suitable support structure such as a crane, truck, fork, bucket or blade of another vehicle, or even a bucket, arm, or blade of the tracked vehicle or machine itself. For example in this latter regard, if the tracked machine is a track hoe, the stick or arm supporting the bucket of the hoe can be used for supporting the apparatus of the invention, and manipulated as required for installing the track. Once the track is installed, the apparatus can be removed, the idler extended, and the vehicle or machine lowered to ready it for operation.

### BRIEF DESCRIPTION OF THE DRAWINGS

FIG. 1 is an exploded view of apparatus of the invention;

FIG. 2 is a top view of apparatus of the invention;

FIG. 3 is a perspective view of a representative tracked vehicle with which the invention can be used;

FIG. 4 is a perspective view of a tracked vehicle with which the invention can be used, showing a track of the vehicle off;

FIG. 5 is an end view of a representative tracked vehicle;

FIG. 6 is a simple five schematic view of a tracked vehicle with a track off;

FIG. 7 is a simple find and view of a tracked vehicle showing steps of a method of the invention for retracking;

FIG. 8 is a simplified schematic side view showing steps of the invention;

FIG. 9 is a simplified top view of a tracked vehicle being retracked using the invention;

FIG. 10 is a simplified side view of a tracked vehicle being retracked using the invention;

FIG. 11 is another simplified top view of a tracked vehicle being retracked using the invention;

FIG. 12 is another simplified side view of a tracked vehicle being retracked using the invention;

FIG. 13 is a simplified perspective view of a typical tracked vehicle with which the invention can be used;

FIG. 14 is a simplified perspective view of another typical tracked vehicle with which the invention can be used;

FIG. 15 is a simplified top view of a tracked vehicle being retracked using the invention;

FIG. 16 is a fragmentary top view of a tracked vehicle being retracked using the invention;

FIG. 17 is another fragmentary top view of a tracked vehicle being retracked using the invention;

FIG. 18 is another fragmentary top view of a vehicle being retracked using the invention;

FIG. 19 is another fragmentary top view of a vehicle being retracked using the invention;

FIG. 20 is a side view showing apparatus of the invention on a tracked vehicle;

FIG. 21 is a fragmentary side view of apparatus of the invention; and

FIG. 22 is a fragmentary perspective view of apparatus of the invention.

### DETAILED DESCRIPTION OF THE INVENTION

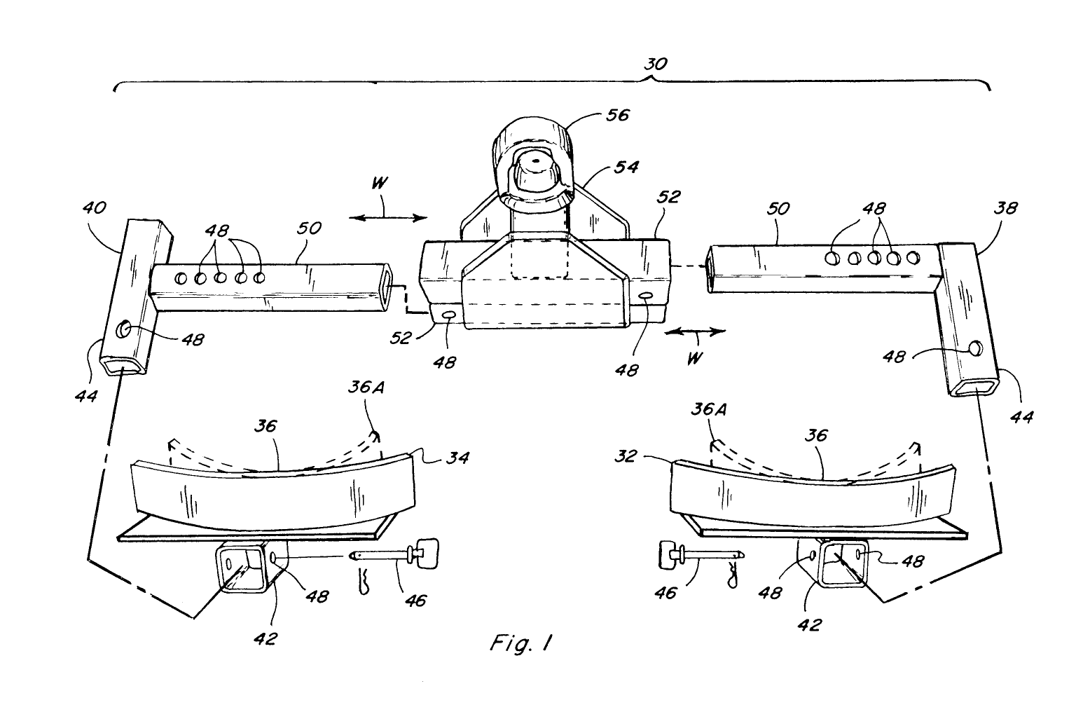

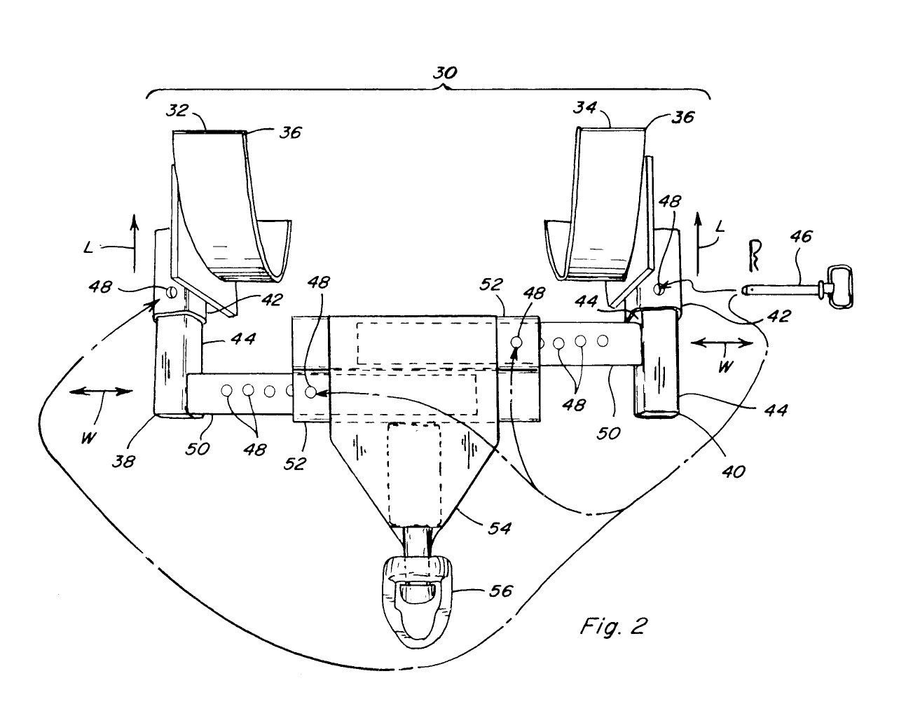

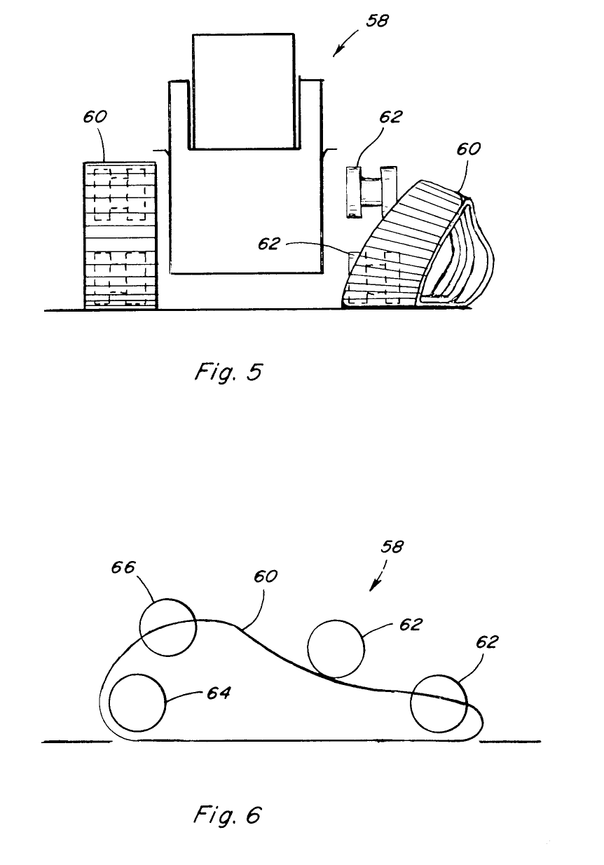

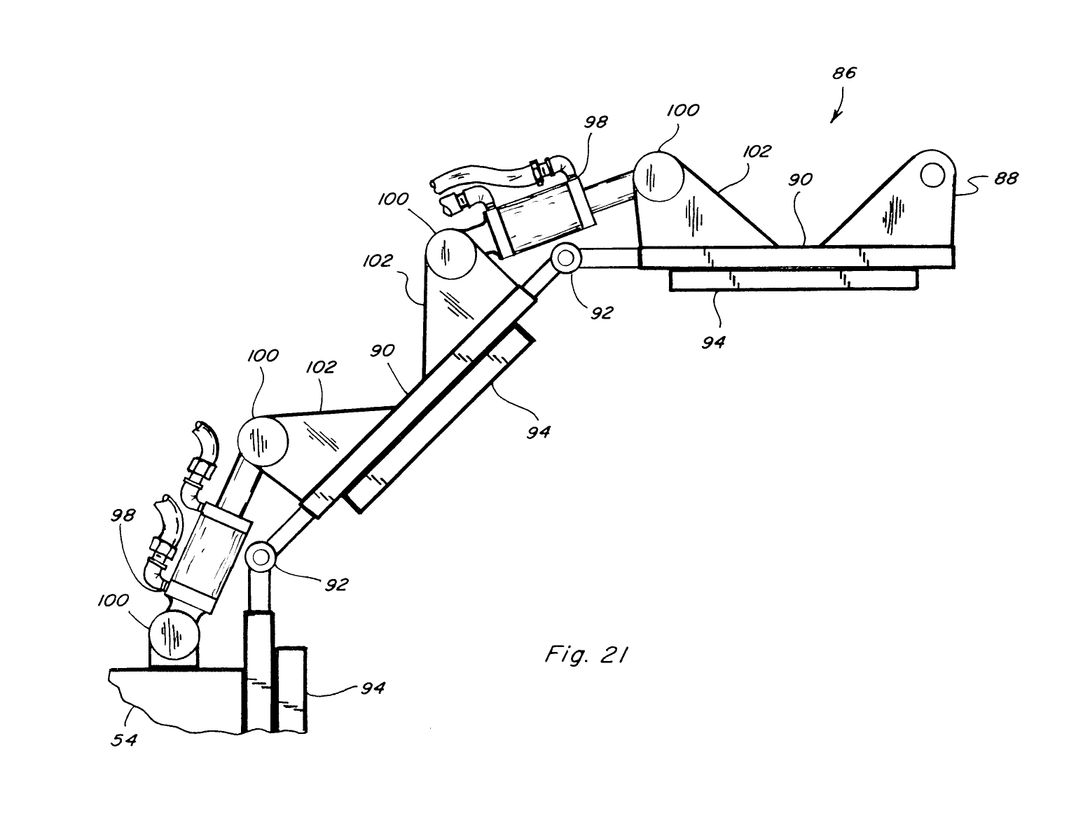

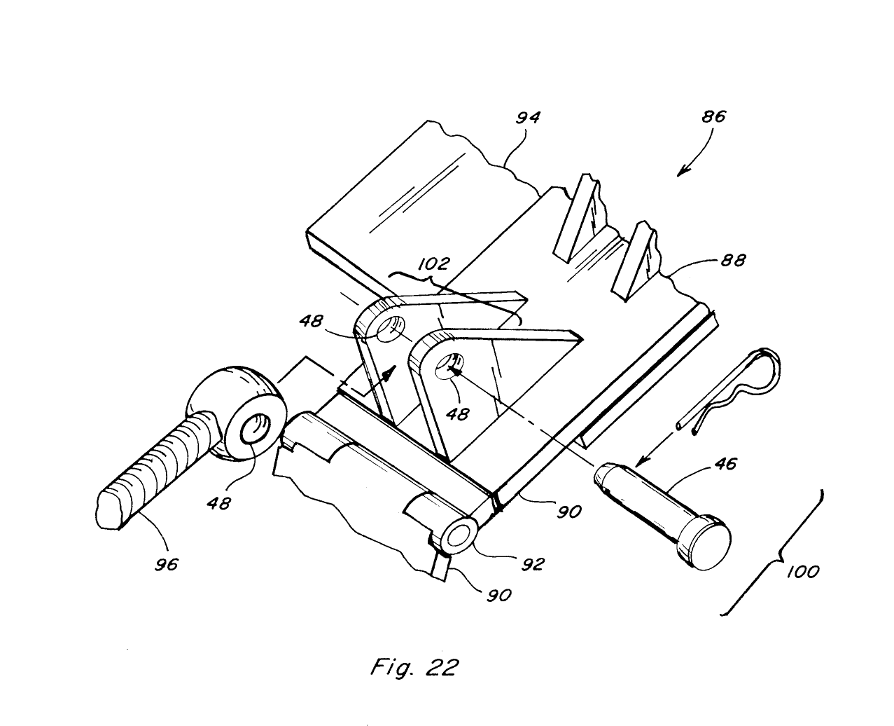

Referring to FIGS. 1 through 21, embodiments of preferred apparatus and steps of preferred methods of the invention are shown. In FIGS. 1 and 2, a preferred apparatus 30 includes a pair of track grippers 32 and 34 configured and operable for gripping at least the edges of the portion of the track to be installed or reinstalled over the idler wheel or sprocket of a tracked work machine or vehicle. Each gripper 32, 34 as an overall arc shape adapted for shaping that portion of the track gripped thereby into an arc of appropriate size for passage laterally over the idler wheel or sprocket, hereinafter also referred to by just the term “idler”, as will be discussed hereinbelow.

Each gripper 32, 34 comprises a rigid structure of tubular or solid metal such as steel or aluminum, and can be a weldment, castings, or extruded shape curved or bent to the desired arc shape and size. With regard to the term “arc shape” this is to be interpreted as including a series of straight segments in end to end, angularly related pattern, forming a generally arced or curved shape, as well as a smoothly curved shape.

Each of the grippers 32, 34 includes a single, continuous gripping element 36 positioned and oriented to extend in an inward direction toward the other gripper 32, 34 and configured for cooperatively engaging the edge of the track for gripping and holding or supporting the track portion in the arc shape, and for carrying it laterally into position on the idler. Here, as a non-limiting example, the single continuous gripping element 36 can comprise a flange or lip formed in the arc shape and size.

Apparatus 30 is configured to allow interchanging ability of different grippers having characteristics adapted for use with particular track types and/or sizes, such as illustrated by alternative grippers 36A in FIG. 1 having a smaller arc radius. Grippers having larger radius arcs can also be provided as desired or required for a particular application. The invention additionally includes adjustable support arms 38, 40 that support and hold the grippers 32, 34 in a generally parallel, spaced apart relation such that the gripping elements of the respective grippers 32, 34 are in opposing relation and are spaced a distance apart corresponding to the width of the track to be installed, so as to be capable of capturing or bounding the portion of the track to be installed onto an idler, as will be explained. In this latter regard, the arms can be adjustable for different width tracks, or non-adjustable but capable of being opened and closed or assembled for positioning about a track of a particular width.

For attachment to support arms 38, 40, each gripper 32, 34 includes a receiver 42, configured to cooperatively receive and connect to a gripper end 44 of arm 38 or 40 by a suitable attachment, such as pins 46 receivable through mating holes 48. Arms 38, 40 additionally include base ends 50 telescopingly receivable in receivers 52 of a main receiver member 54, in parallel relation, and can be held in place therein in any suitable manner, such as using additional pins 46 selectably receivable in holes 48, for setting a width of apparatus 30, as denoted by arrows W. Additional holes 48 can also be provided in gripper ends 44 of arms 38, 40 to allow adjusting the length of that portion of apparatus 30, if desired, as denoted by arrows L. Gripper ends 44 can be of different lengths or other configurations, as illustrated, for compensating for the offset locations of receivers 52, as required. As additional features, apparatus 30 can include lifting elements, such as a swivel ring 56 on member 54, and other eyelets or lifting rings, hooks or the like, as desired or required for a particular application. As other examples, the support arms of the apparatus can be relatively movable via a scissors or pivotal connection or action, as desired. In either instance, the arms can be fixed or retained in a set position via suitable apparatus such as a pinned connection, turnbuckle or hydraulic cylinder, these latter apparatus being usable also for adjustably moving the arms.

According to another aspect of the invention, by virtue of the pinned connections, grippers 32, 34, and support arms 38, 40, can be removed, for breaking down or compacting apparatus 30 for transport and storage, and to allow interchanging different size grippers, e.g., grippers 36A, for use with different size tracks or idlers. Thus, as an example, a larger radius gripper for use with a larger radius idler can be interchanged with a smaller radius gripper for use with a smaller radius idler, and/or a medium size gripper, or a gripper for a different style or type of track, e.g., a rubber track or steel track.

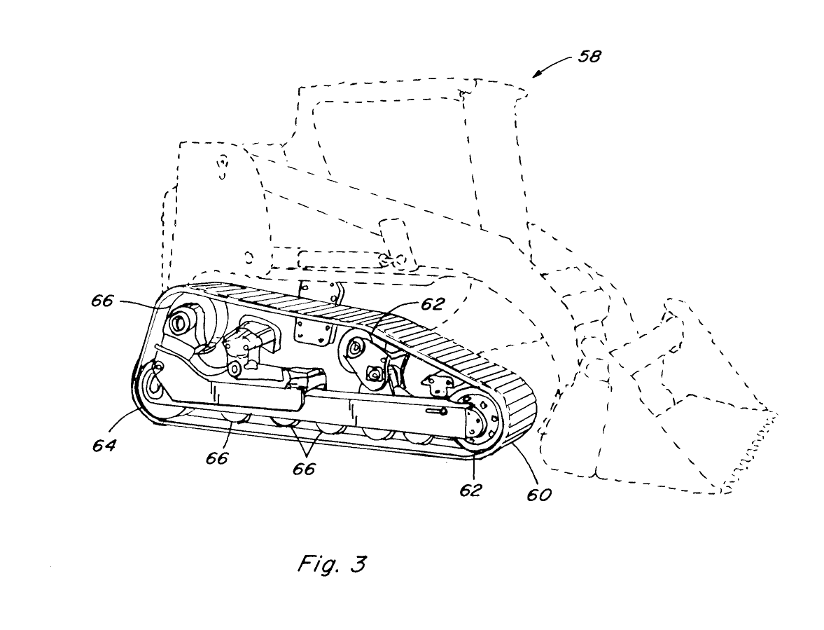

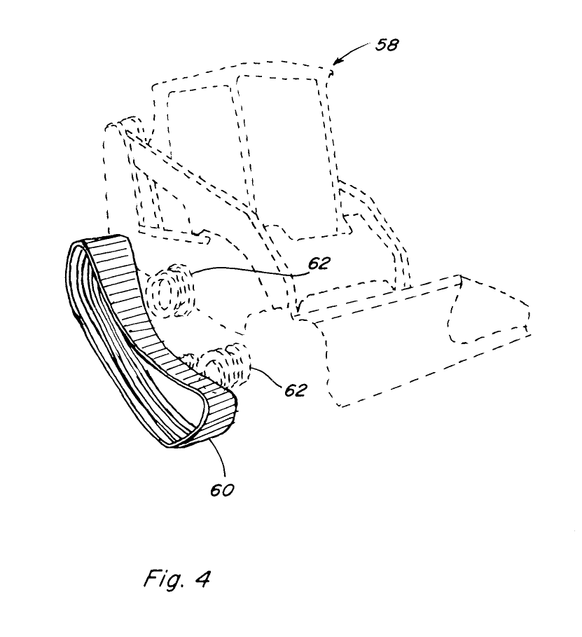

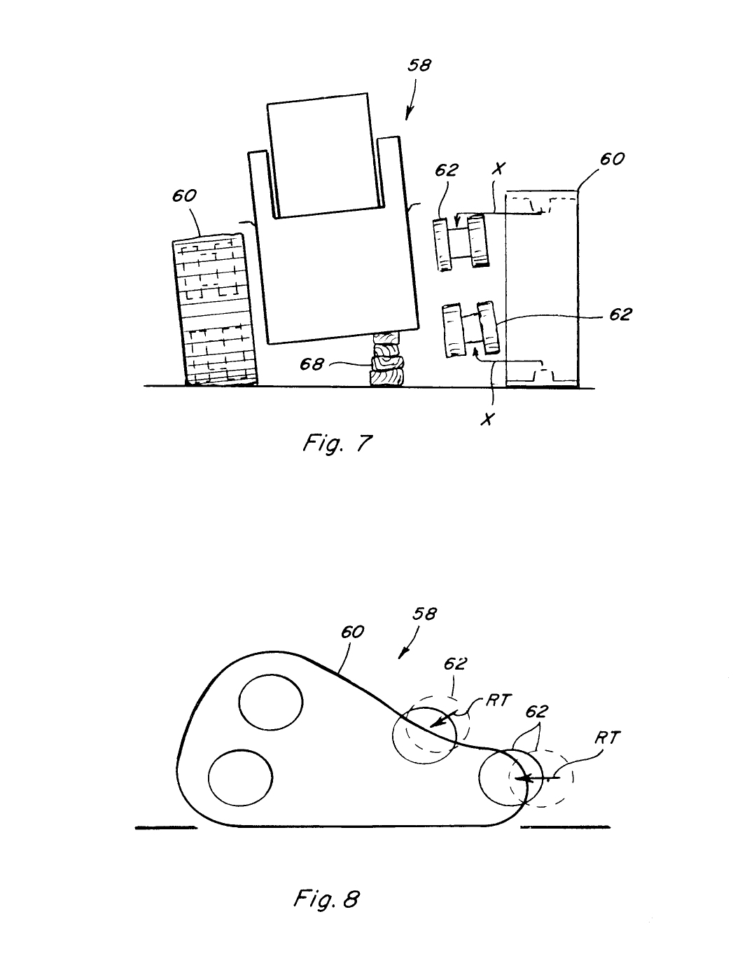

Referring also to FIGS. 3-12, a representative tracked work machine 58 is shown, including with a track 60 on one side untracked in FIGS. 4 through 6, and track 60 being reinstalled according to steps of a method of the invention in FIGS. 7 through 12. Here, machine 58 is a depicted as a compact track loader having tracks 60 on opposite sides of the machine. Tracks 60 can be of rubber or steel construction, and encircle idlers 62 on the front end of the machine and drive wheels 64 on the rear end, with several bogey wheels 66 disposed between a lower idler 62 and drive wheel 64. In operation, with tracks 60 properly installed as illustrated in FIG. 3, drive wheel 64 will be rotated in the well known manner to move track 60 about idlers 62 for propelling machine 58 in one direction the other and for maneuvering and turning the machine. FIGS. 4 through 6 show one of tracks 60 off of idlers 62, which can happen for a variety of reasons, such as, but not limited to, due to wear and looseness of the track, or operation on a surface or under conditions where large lateral forces are exerted to remove the track.

In FIG. 7, as an initial step of the method of the invention, the affected side of machine 58 is raised. This can be accomplished using a jack or jacks, crane, inflatable air bags or the like. To maintain the side of the machine in the raised position, cribbing or timbers 68 are used. This is to enable sliding or moving the affected track 60 laterally toward machine 58, and to take required slack out of it (if any) or tension it to enable installing or fitting it about idlers 62, including any lugs on the track or idler as denoted by arrows X. This installation is accomplished using the apparatus 30 just discussed.

As another initial step, the idlers 62 are retracted, so as to be lowered and/or moved rearwardly, as illustrated by arrows RT in FIG. 8. This provides the clearance for installing track 60.

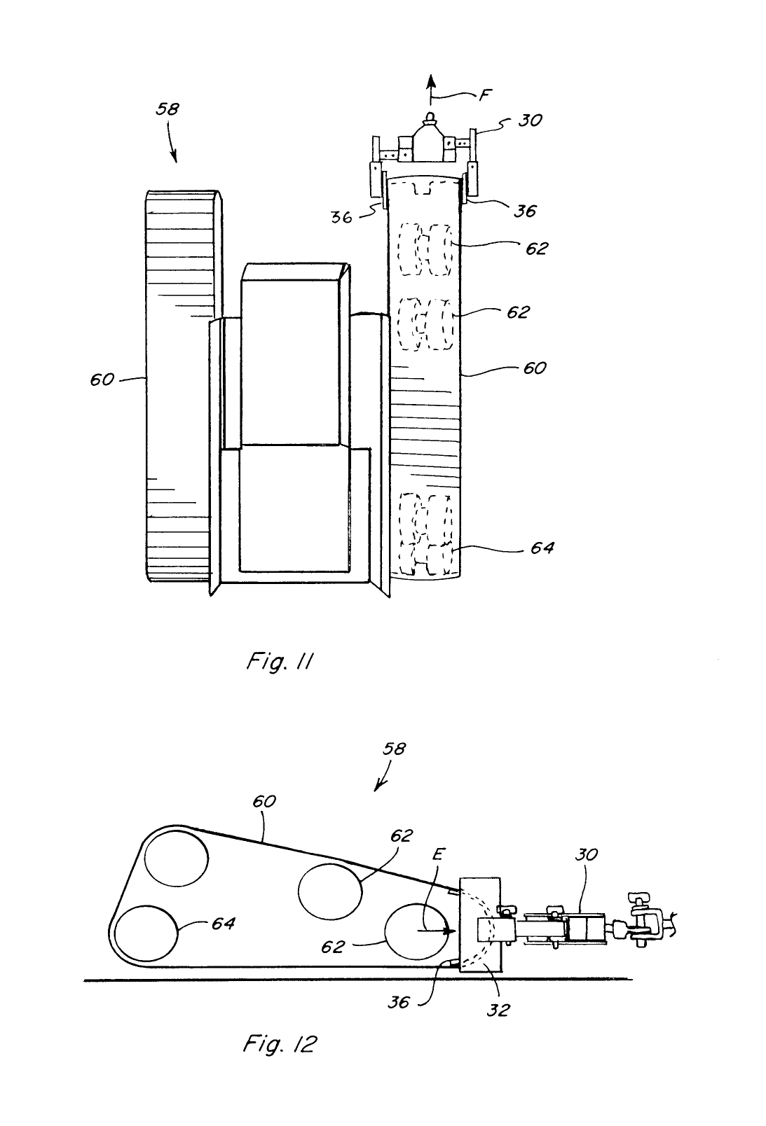

With the side of the machine raised, apparatus 30 is now fitted about the end of track 60. To do this, main receiver member 54 is positioned just in front of track 60. This can be done manually, or using a crane of other lifting device (not shown). Grippers 32 and 34 will be selected so as to have the appropriate arc radius for installing track 60 about idlers 62, which will be a radius marginally larger than the outer circumference of the idlers, as illustrated by the relative size of gripper element 36 and idler 62 in FIG. 10.

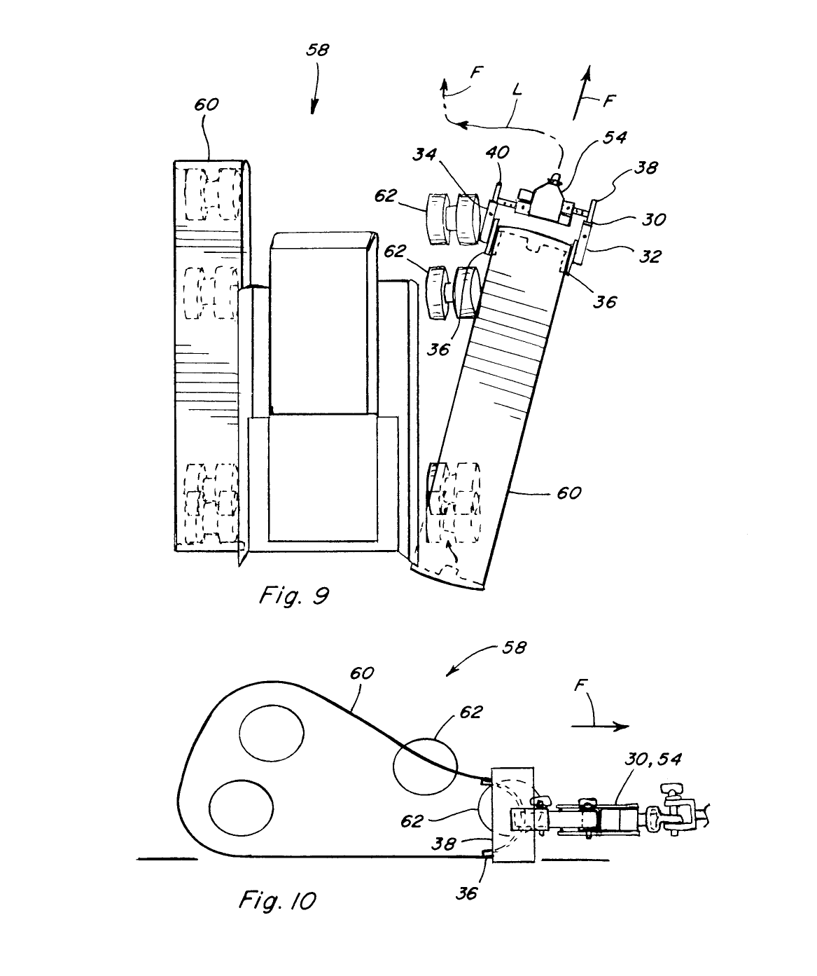

With the end of track 60 supported and shaped by gripping elements 36, apparatus 30 is moved or manipulated, to install the track about idlers 62. This is possible because the end of track 60 is captured or retained by grippers 32, 34. This step involves moving or pulling apparatus 30 forwardly, as denoted by arrows F, to take necessary slack out of or tension the track, and laterally, as denoted by arrow L, into a forward position over idlers 62, as illustrated in FIGS. 9 through 12. This can be performed manually, or using a lifting device, such as a crane, lever, or pry bar or bars.

With track 60 properly installed, idlers 62 are extended, as denoted by arrow E in FIG. 12, and machine 58 lowered to return to operation.

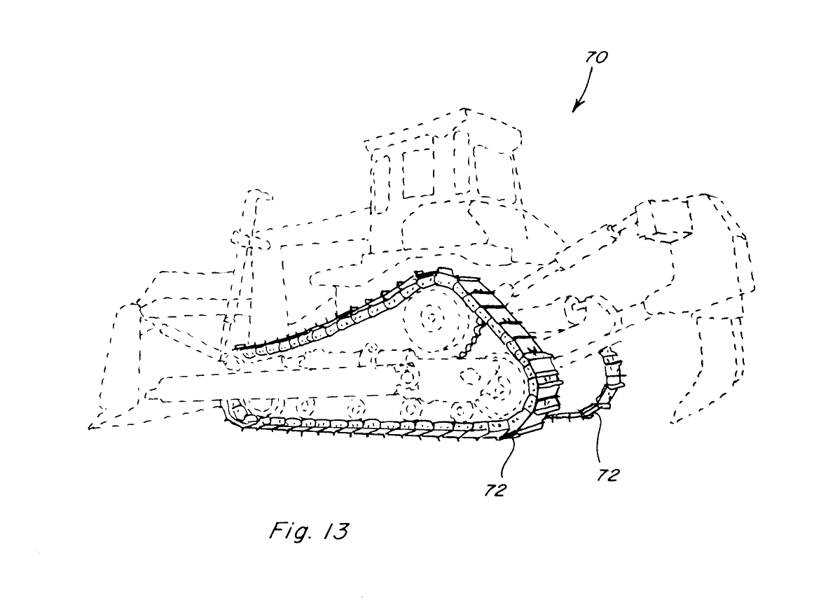

Referring also to FIG. 13, another work machine is shown which is a bulldozer 70 having heavy steel tracks 72, which can be reinstalled using the apparatus and method of the invention, such as an apparatus 30.

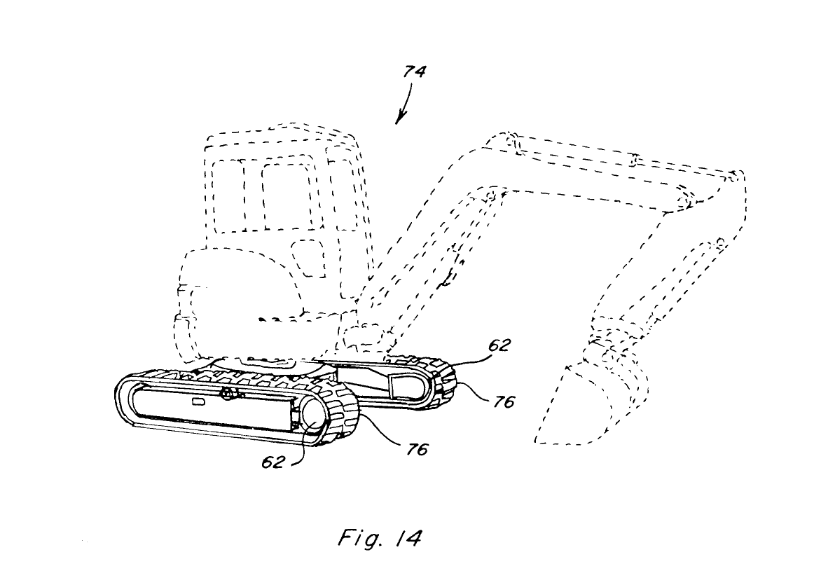

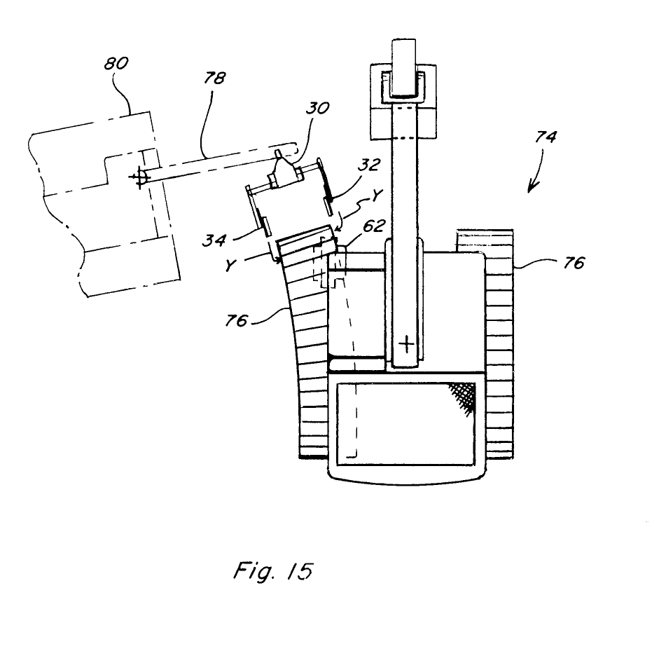

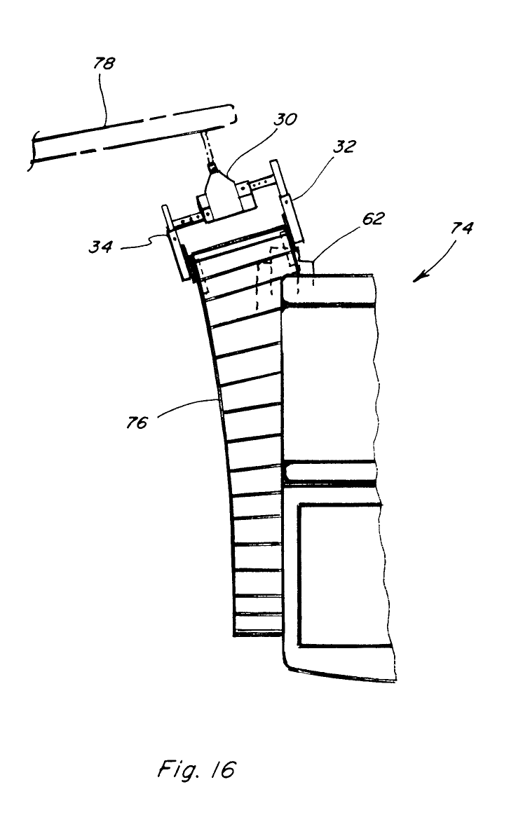

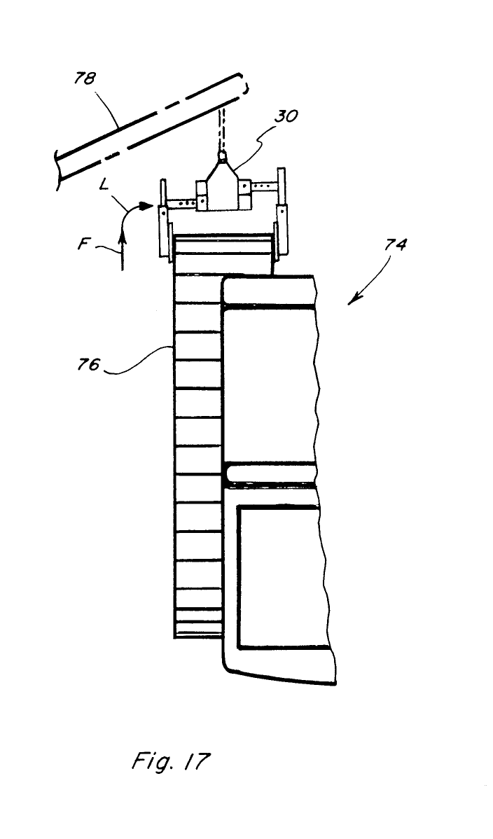

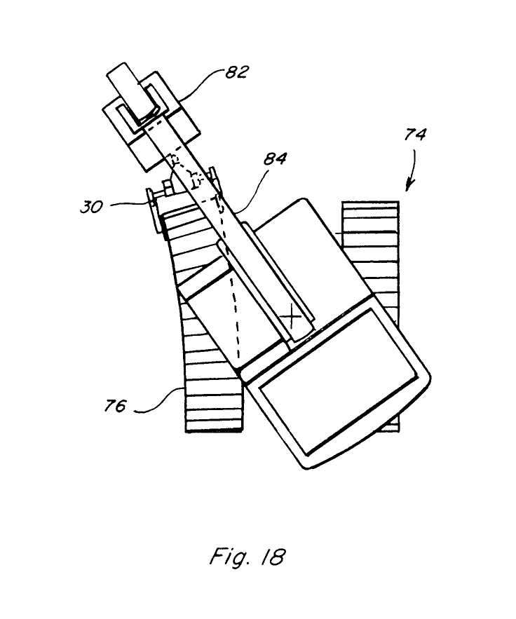

Referring also to FIGS. 14 through 17, a representative tracked excavator 74 is shown, including in FIGS. 15 through 17 having a large track 76 reinstalled about a front idler 62 using apparatus 30 according to the invention. In particular, in FIG. 15, the side of excavator 74 is raised as before, idler 62 is retracted, and apparatus 30 is suspended from a crane 78 of a service truck 80, to allow sizing and fitting grippers 32 and 34 about the end of the track 76, as denoted by arrows Y, in the above described manner. In FIG. 16, grippers 32 and 34 support track 76 from crane 78. Going to FIG. 17, apparatus 30 is moved by crane 78 forwardly and laterally, and upwardly or downwardly, to remove any slack or tension the track as required and install track 76 on the idler, as denoted by arrows F and L. The idler can now be extended, and the excavator lowered for operation.

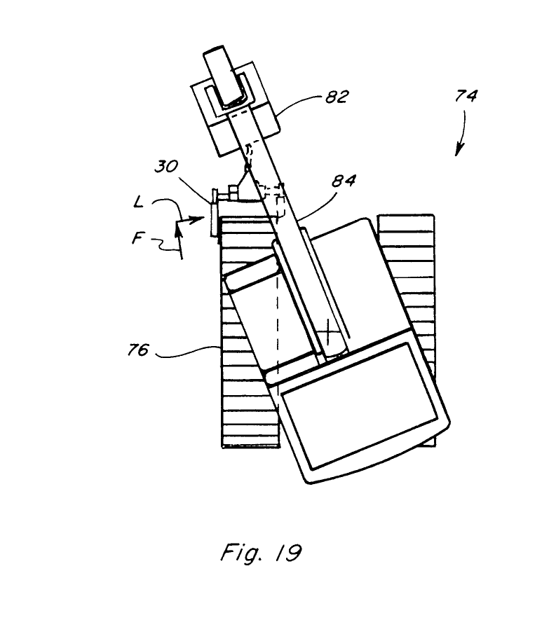

FIGS. 18 and 19 illustrate that the present invention allows some work machines such as excavator 74 to be self-retracking. Here, the bucket 82 of the excavator 74 can be used to lift the side of the excavator, for securing with timbers or the like as before. A jack, air bag or the like could alternatively be used. Idler 62 is retracted as before. Apparatus 30 is suspended from the excavator bucket 82 for fitting about the end of track 76. The stick 84 supporting the bucket and the bucket itself can then be manipulated to move apparatus 30 and track 76 forwardly, laterally, and upwardly and downwardly as required, as denoted by arrows F and L into position on the idler. The idler is then extended as before and the machine lowered for operation.

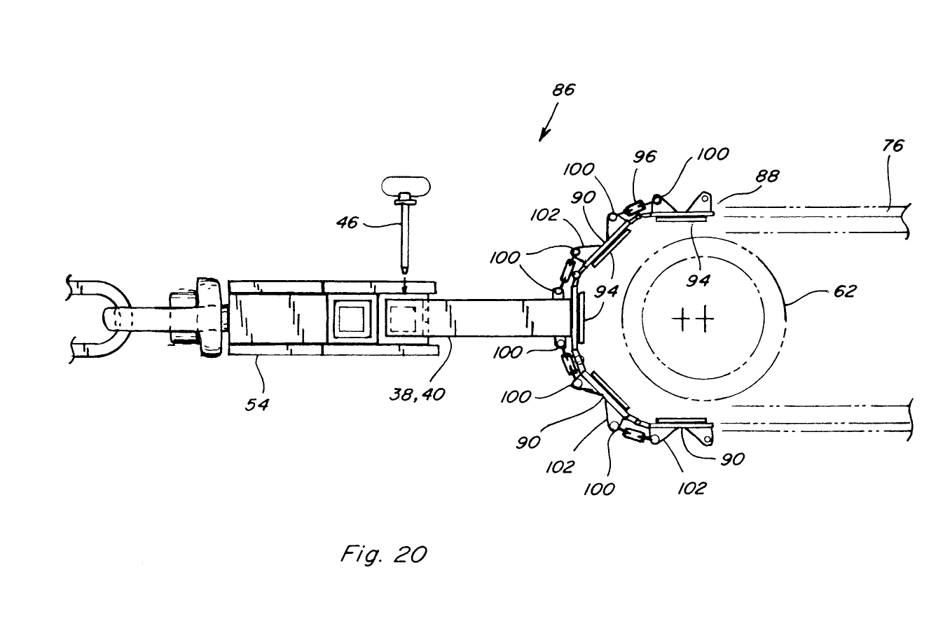

Referring also to FIGS. 20, 21 and 22, another embodiment of an apparatus 86 for installing a track, such as track 76 about an idler 62 of any of a variety of tracked work machines or vehicles according to the invention is shown. Apparatus 86 differs from apparatus 30 primarily in the provision of adjustable size grippers 88, supported on adjustable arms 38 and 40 adjustably carried on and movable relative to a main receiver member 54, and fixable in a selected spaced apart width using a pin 46, in the above described manner.

Each gripper 88 consists of several gripper segments 90, here numbering 5, joined together in end to end relation by hinge joints 92 to allow relative hinged movement thereabout. A middle gripper segment 90 is fixed to arm 38 or 40. Each gripper segment 90 includes a gripping element segment, which is preferably a flat plate or strip of suitable metal such as steel or aluminum, projecting sidewardly therefrom and adapted for cooperatively engaging a portion of track 76 for forming it into the required arc shape and size for installing about idler 62, essentially in a manner equivalent to that described above.

Here, it should be noted that the arc shape is actually comprised of the angularly related segments 90 and thus is considered to be equivalent to and representative of an actual arc shape for the purposes of the invention.

Adjacent ones of gripper segments 90 are additionally connected together by adjusting members which here can comprise, as non-limiting examples, turnbuckles 96 or hydraulic cylinders 98. Turnbuckles 96 and cylinders 98 are connected to the respective gripper segments 90 by pivot joints 100, each comprising a clevis 102 on the ends of the respective segments 90, pivotally connected to the end of the turnbuckle or cylinder by a pin 46 received through holes 48 in the respective members. As a result, shortening the turnbuckle or cylinder between adjacent segments 90 will increase the angle therebetween and thus the radius or size of the arc, and lengthening them will decrease the radius or size.

Here, it should be noted that as an advantage of the use of angularly related segments 90, a wide variety of sizes can be achieved. As another advantage, for a track consisting of angularly related or hingedly connected tread plates, the flat gripping elements can make better surface to surface contact with those plates, so as to possibly provide better gripping and holding strength. Good holding strength can also be achieved with rubber tracks. When adjusting turnbuckles 96, an appropriate tool such as a wrench can be used. Pressurized hydraulic fluid for cylinders 98 can be provided by connection to the machine or vehicle being retracked, if available, or connection to a system of a service truck or portable hydraulic system, which enables operation remotely and with less manual effort.

Apparatus 86 can be supported in any of the above described manners, e.g., by a service truck or crane, gantry, or bucket or other suitable movable member of a vehicle or machine, for installation of a track such as track 76 in any of the above described manners. The side of the vehicle or machine can be raised and supported using a crane, or with a jack or jacks, or an inflatable bag or bags. The vehicle or machine can also be supported on timbers, stands, cribbing, or an inflated bag or bags during the installation.

It should be apparent that the apparatus of the invention shall be of sufficient size and robustness for shaping, supporting and holding the track to be installed. This will entail selection of grippers sufficiently large to form the end of the track in a large enough arc shape to partially encircle the idler with sufficient margin for passage of the lugs over the circumference of the idler. The grippers and apparatus must also be robust enough to extend or tension the track, and to move it laterally. This can be supplemented by additional support apparatus below apparatus 30 or 86, such as wheels, skids, a fork or forks, or a bucket or blade of another vehicle.

In light of all the foregoing, it should thus be apparent to those skilled in the art that there has been shown and described a novel apparatus and method for installing a track on a tracked vehicle. However, it should also be apparent that, within the principles and scope of the invention, many changes are possible and contemplated, including in the details, materials, and arrangements of parts which have been described and illustrated to explain the nature of the invention. Thus, while the foregoing description and discussion addresses certain preferred embodiments or elements of the invention, it should further be understood that concepts of the invention, as based upon the foregoing description and discussion, may be readily incorporated into or employed in other embodiments and constructions without departing from the scope of the invention. Accordingly, the following claims are intended to protect the invention broadly as well as in the specific form shown, and all changes, modifications, variations, and other uses and applications which do not depart from the spirit and scope of the invention are deemed to be covered by the invention, which is limited only by the claims which follow.

What is claimed is:

1. An apparatus or tool for installing a continuous loop of track onto the idler wheel or sprocket of a tracked vehicle, comprising:
a pair of track grippers configured and operable for gripping at least opposite edges of a portion of the track to be installed over the idler wheel or sprocket, and shaping the portion of the track into an arc of appropriate size for passage laterally over the idler wheel or sprocket, each of the grippers having a rigid, generally arcuate or angular shape suitable for gripping the opposite edges of the portion of the track portion for forming and holding it in an arc;
arms that support and hold the grippers in a generally parallel, spaced apart relation such that the gripping element or elements of the respective grippers are in opposing relation and are spaced a distance apart corresponding about to the width of the track, so as to be capable of capturing or bounding the portion of the track to be installed onto the idler, and for positioning the gripping element or elements for supporting and holding the track in the arc shape; and
apparatus in connection with the grippers configured and operable for moving the grippers apart to enable placing the track therebetween.
